(19) United States
(12) Patent Application Publication
(10) Pub. No.: US 2023/0298149 A1
(43) Pub. Date: Sep. 21, 2023

(54) METHODS FOR GENERATING LEARNED MODELS, IMAGE PROCESSING METHODS, IMAGE TRANSFORMATION DEVICES, AND PROGRAMS

(71) Applicant: NIKON CORPORATION, Tokyo (JP)

(72) Inventors: Toru ICHIHASHI, Tokyo (JP); Takahiko YOSHIDA, Tokyo (JP); Moeka NOBUTA, Tokyo (JP); Yasuko OSHIMA, Tokyo (JP); Junko SAKAGAMI, Tokyo (JP); Takayuki UOZUMI, Tokyo (JP)

(73) Assignee: NIKON CORPORATION, Tokyo (JP)

(21) Appl. No.: 18/201,926

(22) Filed: May 25, 2023

Related U.S. Application Data
(63) Continuation of application No. PCT/JP2020/044564, filed on Nov. 30, 2020.

(51) Int. Cl. G06T 5/50

(52) U.S. Cl. CPC G06T 5/50; G06T 2207/10056; G06T 2207/30024; G06T 2207/20081; G06T 2207/20216

(57) ABSTRACT

A method for generating a learned model that performs an image transformation disclosed in the present description includes a step of learning mapping of a source to a target using a first image group as the source and at least one phase contrast image as the target, the first image group including a first image set having microscopic images of a biological sample captured at different positions along a first optical axis, the microscopic images being other than phase contrast images.

### INCORPORATION BY REFERENCE

This is a Continuation Application of International Application No. PCT/JP2020/044564, filed on Nov. 30, 2020. The contents of the aforementioned applications are incorporated herein by reference.

### TECHNICAL FIELD

The present invention relates to methods for generating learned models, image processing methods, image transformation devices, and programs.

### BACKGROUND

Conventional techniques are known to transform bright-field images of cells into images like phase-contrast images by artificial intelligence (AI) (see, for example, Patent document 1: JP2020-60822).

### SUMMARY

The present disclosure provides novel methods for generating learned models, image processing methods, image transformation devices, and programs.

An aspect of the present disclosure is a method for generating a learned model that performs an image transformation, the method including: a step of learning mapping of a source to a target using a first image group as the source and at least one phase contrast image as the target, the first image group including a first image set having microscopic images of a biological sample captured at different positions along a first optical axis, the microscopic images being other than phase contrast images.

Another aspect of the present disclosure is an image processing method including the steps of: acquiring a first image of a biological sample for image transformation, the first image being other than a phase contrast image; supplying the first image to a learned model and performing image transformation to generate a second image, the learned model having been generated using, as data for training, source image data and target image data, the source image data having microscopic images of a biological sample for the first training captured at positions different from the first image along an optical axis by the same imaging method as the one used for capturing the first image, the target image data having phase contrast images of a biological sample for a second training; and outputting the second image.

Yet another aspect of the present disclosure is an image processing method including the steps of: acquiring an image set having microscopic images of a biological sample captured at different positions along an optical axis of an objective lens, the microscopic images being other than phase contrast images; and supplying one or more first images selected from the image set to a learned model and performing image transformation to generate one or more second images, the number of the first image(s) being equal to the number of the second image(s), the learned model having been generated using, as data for training, source image data and target image data, the source image data having microscopic images of a biological sample for a first training captured by the same imaging method as the one used for capturing the image set, the microscopic images of the source image data being other than phase contrast images, the target image data having phase contrast images of a biological sample for a second training.

### BRIEF DESCRIPTION OF THE DRAWINGS

FIG. 1A is a schematic diagram of an image processing system according to an embodiment of the present invention.

FIG. 1B is a schematic diagram of an image processing system according to an embodiment of the present invention.

FIG. 1C is a schematic diagram of an image processing system according to an embodiment of the present invention.

FIG. 1D is a schematic diagram of an image processing system according to an embodiment of the present invention.

FIG. 2 is a flowchart of an entire image processing method according to an embodiment of the present invention.

FIG. 3 is a flowchart for setting up images for a source according to an embodiment of the present invention.

FIG. 4 is a flowchart for generating a learned model according to an embodiment of the present invention.

FIG. 5 is a diagram showing GUIs according to an embodiment of the present invention.

FIG. 6 is a flowchart for transforming an image at a focal position according to an embodiment of the present invention.

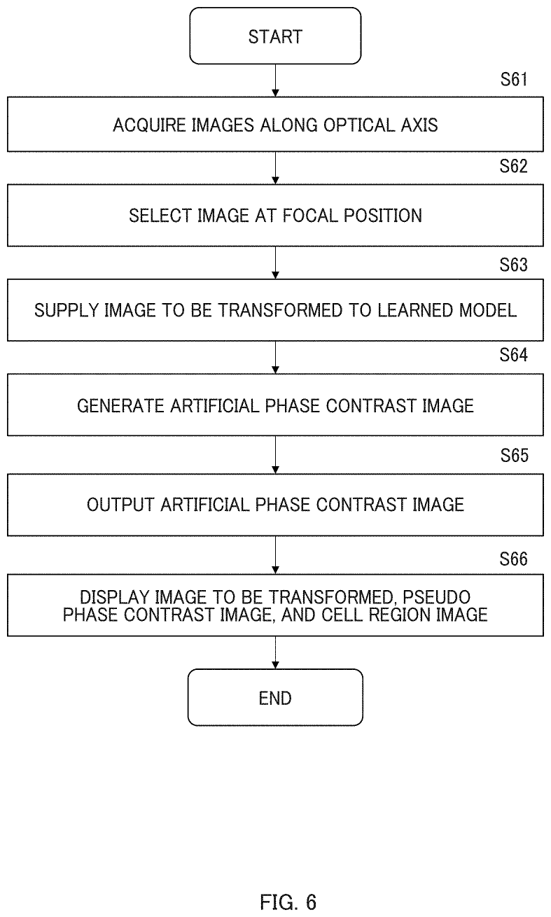

FIG. 7 is a flowchart for identifying a focal position in an embodiment of the present invention.

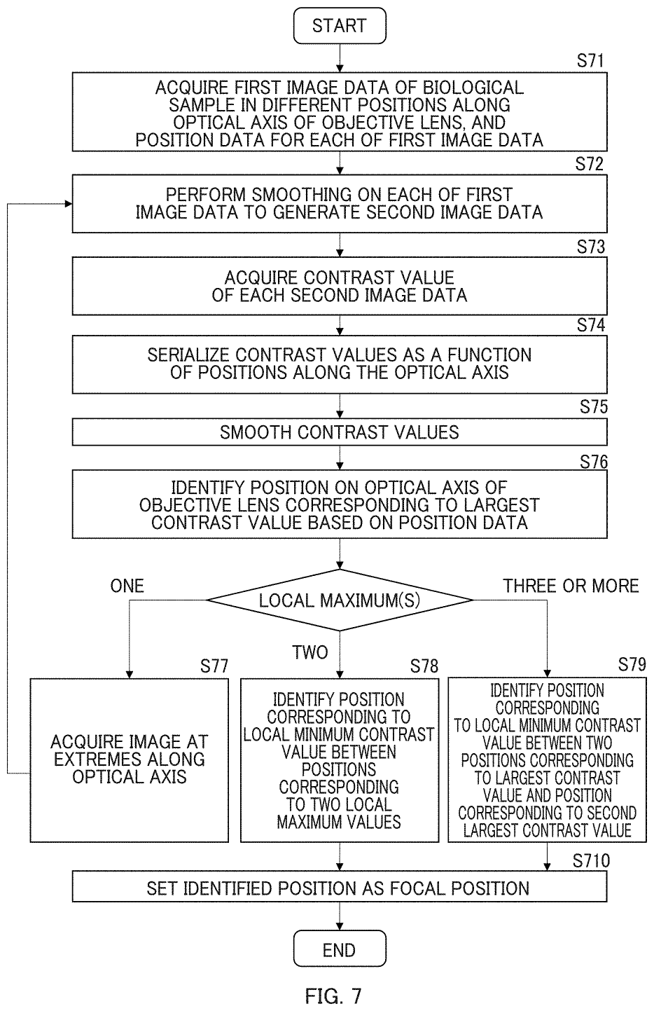

FIG. 8 is a flowchart for converting a plurality of first images into a single second image in an embodiment of the present invention.

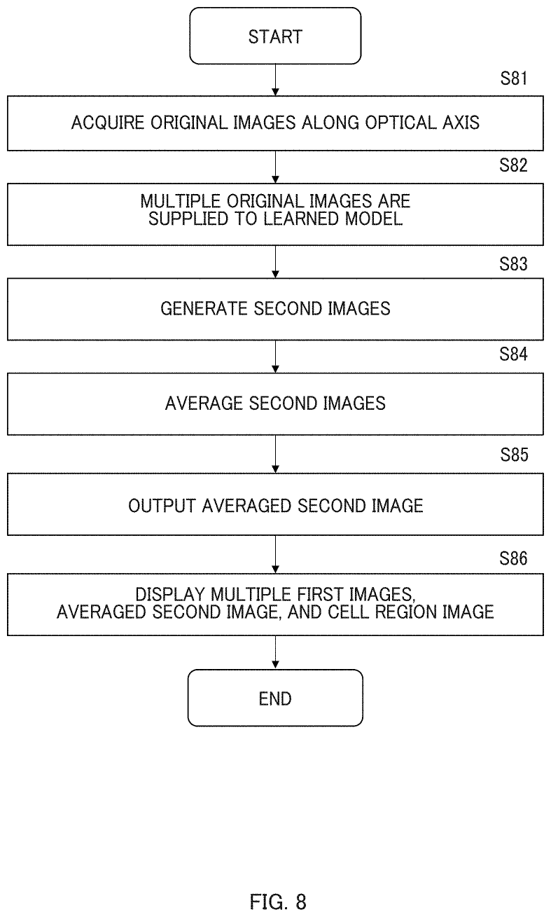

FIG. 9 shows photographs illustrating the results of transformation from different “z” positions in an example of the present invention.

### DESCRIPTION OF EMBODIMENTS

An embodiment of the technique of the present disclosure is described in detail below with reference to the accompanying drawings. The embodiment and a specific example, etc. of the present invention described below are shown for the purpose of illustration or explanation, and are not intended to limit the present invention thereto.

The image processing described in the example is only an example, and that one or more unnecessary steps may be omitted, one or more new steps may be added, or the order of processing operations may be changed when implementing the technique of the present disclosure to the extent that such omission, addition and/or change is/are made without departing from the spirit of the present disclosure.

All references (patent documents and non-patent literatures) and technical standards described herein are incorporated herein by reference as if specifically and individually described herein.

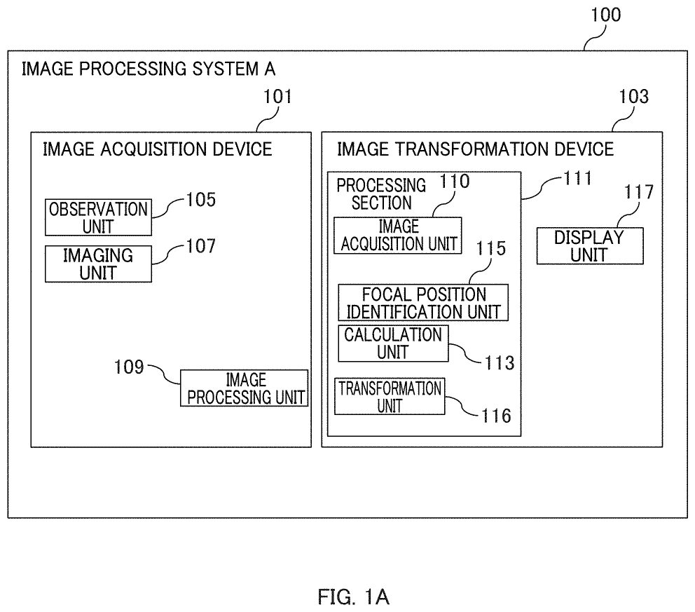

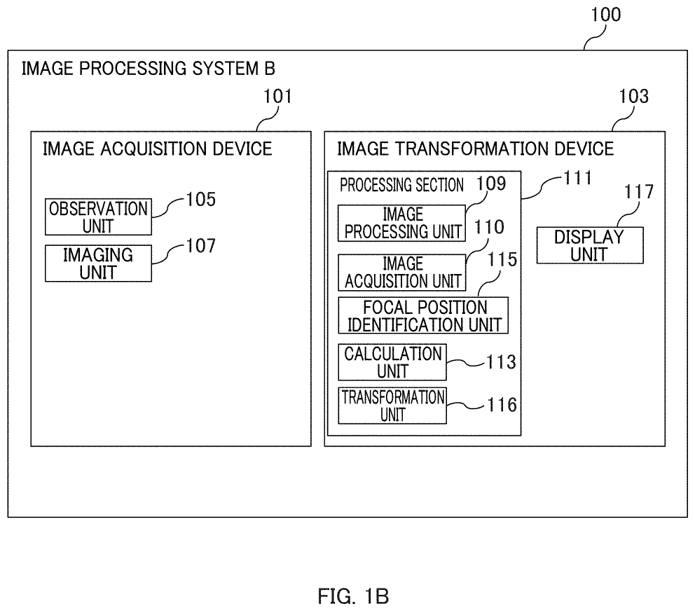

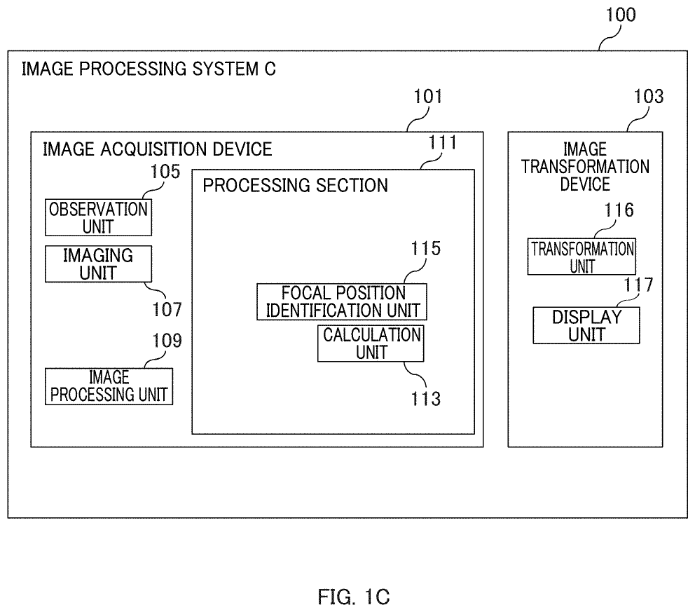

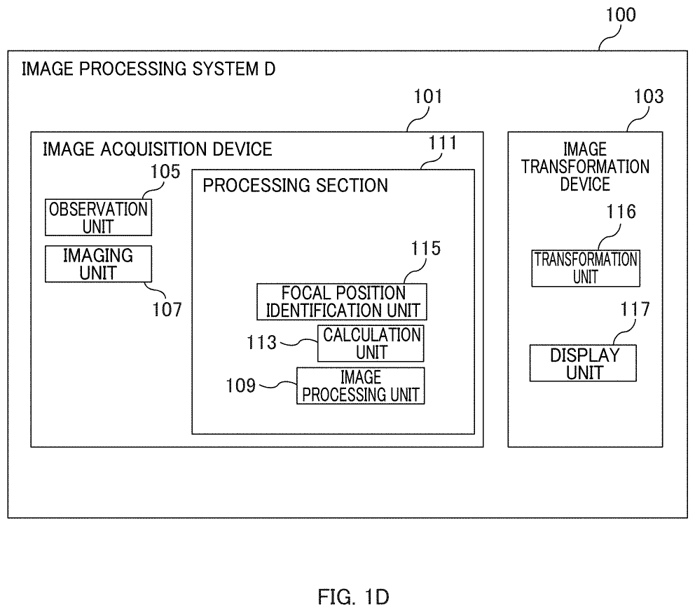

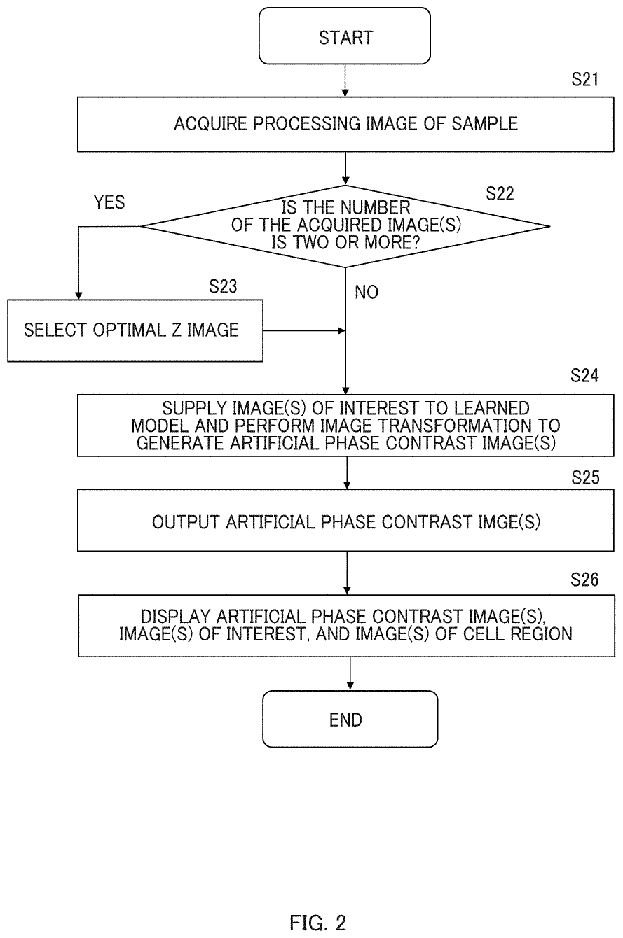

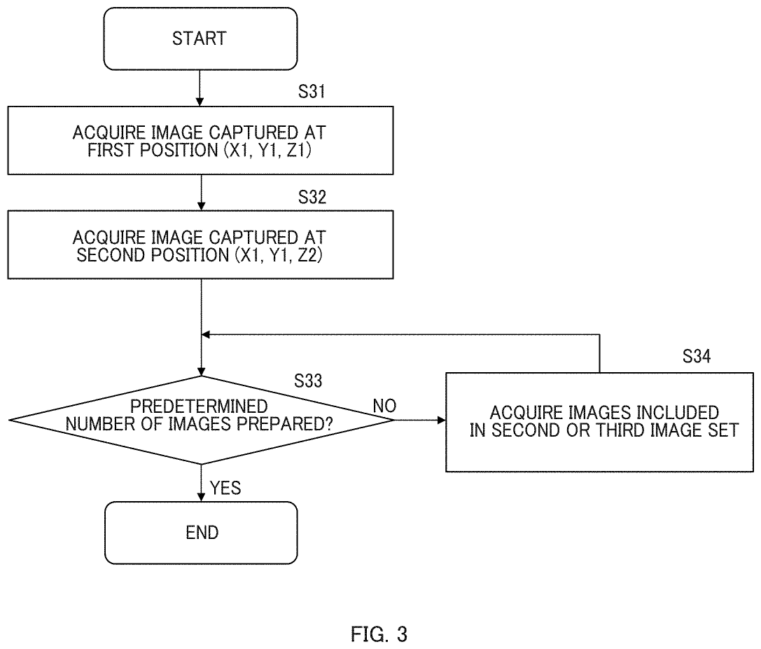

An embodiment of the technique of the present disclosure is an image processing method comprising the steps of: acquiring one or more first images of a biological sample for image transformation, the first image(s) being other than a phase contrast image; and supplying one or more first images to a learned model and performing image transformation to generate one or more second images that are equal in number to the first image(s), the learned model having been generated using, as data for training, source image data and target image data, the source image data having microscopic images of a biological sample for a first training captured at positions different from the first image along an optical axis by the same imaging method as the one used for capturing the first image, the target image data having phase contrast images of a biological sample for a second training. Each of these steps is described in detail below with reference to a system configuration in FIG. 1 and flowcharts in FIGS. 2 and 3.

<Image Acquisition>

An image transformation system 100 of the present disclosure comprises an image acquisition device 101 and an image transformation device 103 (FIG. 1).

The image acquisition device 103 comprises an observation unit 105 and an imaging unit 107. The observation unit 105 is, for example, a microscope suitable for observing an object to be observed. If the object to be observed is a biological sample, the observation unit 105 is, for example, a bright-field microscope, a fluorescence microscope, or a differential interference contrast microscope. Examples of the imaging unit 107 include an imaging device such as a CCD. With the observation unit 105 being installed on a horizontal plane, one direction in the horizontal plane is referred to as an “X direction” and the other direction perpendicular to the X direction in the horizontal plane is referred to as a “Y direction.” The direction parallel to the optical axis of imaging optics, which is perpendicular to the horizontal plane, is referred to as a “Z direction.” The object to be observed is placed on the horizontal plane so that it is located on the optical axis in the Z direction. The X, Y, and Z directions are perpendicular to each other.

The image processing system 100 acquires a first image of the object to be observed, by the observation unit 105 and the imaging unit 107 (S21). Since the first image has not yet been subjected to image transformation described below, it is also referred to as an original image or an image for transformation herein.

The biological sample as an object to be imaged is not limited and may be derived from multicellular organisms such as animals and plants, or from unicellular organisms such as bacteria. Examples include unstained cultured cells, tissues, and organs. Specifically, examples include living cells that are cultured in monolayer or multilayer while adhering to a culture vessel, or cultured as single cells or cell aggregates in suspension. A target component within the object to be observed may be an entire cell, or it may be an intracellular organelle such as a nucleolus, or a cell membrane. The culture vessel may be a container used for typical cell cultures, such as a dish or well plate, or an organ-on-a-chip.

The image processing system 100 may obtain a first image by the observation unit 105 and the imaging unit 107, or it may retrieve, from a memory, a first image stored therein with association to a specific sample ID.

The number of the first image(s) may be one, two or more (S22). If there are multiple images of the object to be observed as candidate images for transformation which were captured at different positions along the optical axis of the observation unit 105, the image processing unit 109 may select the optimal image from the multiple images as a transformed image (S23). The optimal image is, for example, an image of the object to be observed, captured at a focal position or an image thereof captured at a position closest to the focal position. As will be described later, in order to obtain, by the image transformation, an image with the object to be observed being pseudo in-focus, it is preferable that the original image is also a image with the object to be observed being in-focus or an image with an in-focus near the object to be observed.

In the present specification, the focal position refers to a position at which a portion of a sample or a portion of tissue in the sample is in focus in an image. When reference is made to a focused image and an image or images in the vicinity of the focal position, it is intended to refer to images acquired at positions within a certain range centered on the focal position. As an example, the focused image can be an image acquired at a distance of up to 5% of an observation range centered on the focal position. Moreover, an image acquired in the vicinity of the focal position or near the focal position may be, for example, an image acquired at a distance of up to 20% of the observation range centered on the focal position. Provided that the objective lens has a magnification of 10×, an area in the vicinity of the focal position can be defined within a range of 10 μm up and down from the focal position. The image processing unit 109 may be located in the image acquisition device 101 (FIGS. 1A, 1C, and 1D) or in the image transformation device 103 (FIG. 1B). When the image processing unit 109 is in the image acquisition device 101, the first image(s) can be used without any subsequent processing after being obtained by the observation unit 105 and the imaging unit 107. On the other hand, when the image processing unit 109 is in the image transformation device 103, an image acquisition unit 110 in the image transformation device 103 acquires a first image from the image acquisition device 101 and then the first image is processed by the image processing unit 109.

<Image Transformation>

The image transformation device 101 acquires, at the image acquisition unit 110 and from the image acquisition device 103, one or more first images that are not phase contrast images of a biological sample for image transformation. If a single first image is used, it may be a focused image captured at the focal position or an image other than a focused image captured at a position other than the focal position. If the number of the first images is two or more, they may be images captured at different positions along the optical axis of the objective lens.

The acquired original image(s) is/are supplied to a learned model stored in a transformation unit 116 (S24). Here, if the original image is a bright-field image, it is supplied to a learned model trained on bright-field images as the source images. The number of the original image(s) supplied may be one. If multiple images were acquired, each of the acquired images may be supplied, or one or more specific images may be selected from them and then supplied.

A method for generating a learned model will be described later. The learned model used here has been trained by an image transformation network, using images captured with the same observation method (e.g., using the same modality) as the one used for the original image as a group of source images and phase contrast images as target images. Accordingly, by supplying the original image(s) to the learned model, an image with a different image style like a phase contrast image is obtained with the position of an object captured in the original image remains the same. The image generated by the style change is referred to as an artificial phase contrast image or pseudo phase contrast image.

The learned model uses, as the source images, images acquired at different positions along the optical axis. The source images include not only an image captured at a focal position for a sample, but also an image captured near the sample's focal position. Thus, the group of source images includes focused images and images that are somewhat out of focus. On the other hand, the phase contrast images used as target images are those obtained by focusing on the focal position and observing the phase difference.

By performing image transformation using this learned model, focused artificial phase contrast images can be obtained even if the original images are somewhat out of focus. In other words, when an object of which image is to be captured is a cell, artificial phase contrast images generated by changing the image style will provide a clear cell structure, even if the original images are those acquired near the focal position rather than those in which the cell structure is exactly in focus.

<Displaying Images>

The artificial phase contrast image transformed by the learned model is output (S24) and caused to be displayed on a viewer which is a display unit 117 (S25).

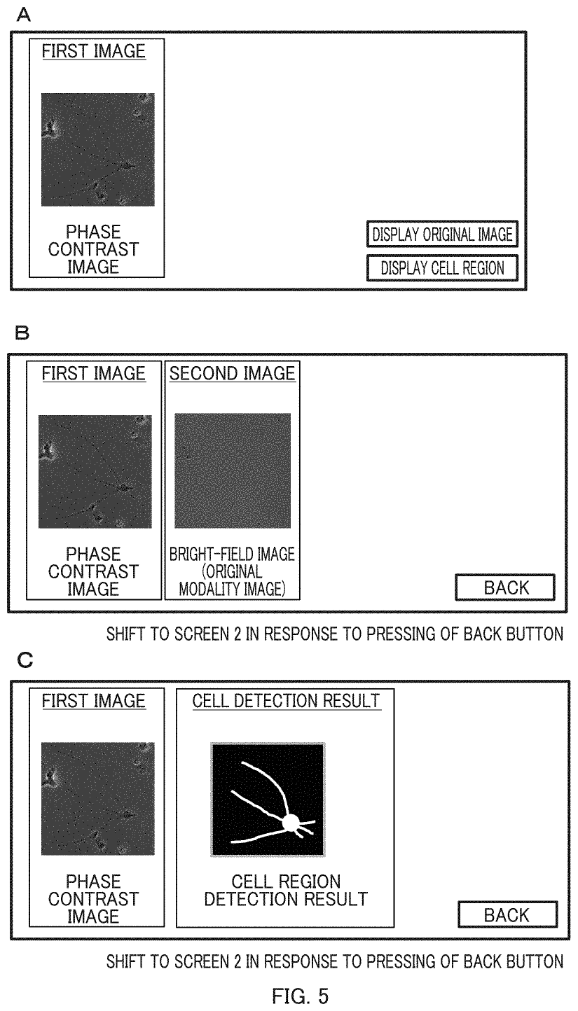

After obtaining the artificial phase contrast image, it may be caused to be displayed alone (FIG. 5A); or one or more locations of the biological sample may be caused to be detected in the artificial phase contrast image to generate a new image, and these images may be caused to be displayed side by side (FIG. 5C); or the original image before transformation may also be output along with the artificial phase contrast image and caused to be displayed on a viewer together with the artificial phase contrast image (FIG. 5B). Alternatively, these three different kinds of images may be caused to be displayed on the display unit 117.

<Method for Generating a Learned Model

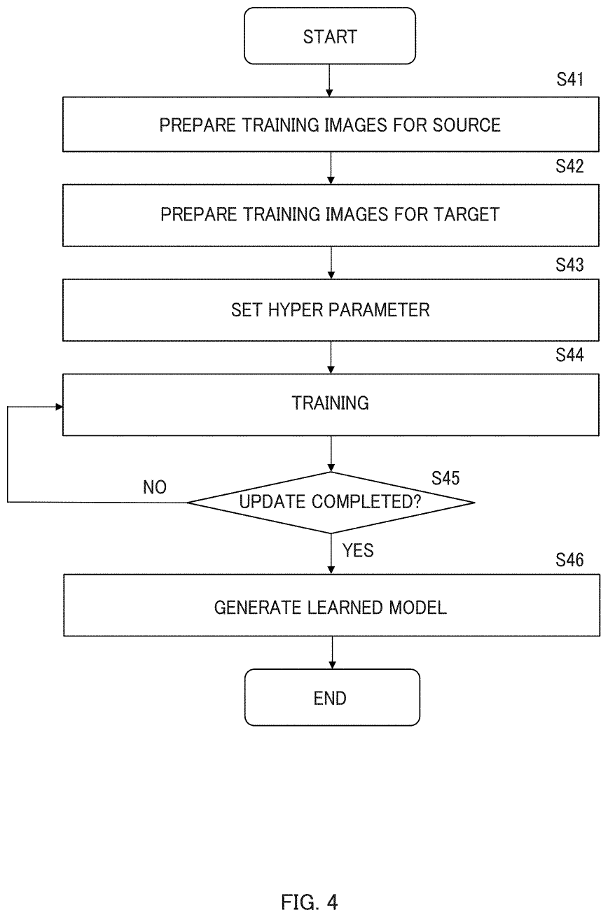

A method for generating a learned model of the present disclosure utilizes an image transformation network, and comprises a step of learning mapping of a source to a target using a first image group as the source and at least one phase contrast image as the target, the first image group comprising a first image set having microscopic images of a biological sample captured at different positions along a first optical axis, the microscopic images being other than phase contrast images. This method for generating a learned model is described with reference to the flowchart illustrated in FIG. 4.

«Preparation of Images for Training»

In generating a learned model, images for training are prepared first. As the images for training, training images for the source are prepared (S41), and then training images for the target are prepared (S42).

«<Acquisition of Source Images»>

A first group of images is acquired as the training images for the source. The images included in the first image group were acquired in a modality that is different from the modality of a phase contrast microscope, and the images in the first image group were acquired in the same modality. For example, if the first image group is a bright-field image group, it has multiple bright-field images. Alternatively, for example, if the first image group is a differential interference image group, it has multiple differential interference images. Alternatively, for example, if the first image group is a fluorescence image group, it has multiple fluorescent images.

The first image group includes a first image set having a plurality of images of a first sample captured at different positions along a first optical axis. The first image set has a plurality of images captured at different positions along the optical axis at a first observation position of the first sample. For example, the first image set includes an image captured at a first position (x1, y1, z1) (S31) and another image captured at a second position (x1, y1, z2) (S32) that shares the same coordinates as the first position in the x- and y-dimensions but has a different coordinate in the z-dimension. The distance between adjacent positions at which the images are acquired in the direction of the optical axis is not particularly limited; however, it is preferable that the distances are equal to each other along, for example, the first optical axis. The images to be acquired are not particularly limited, but are chosen within an appropriate range depending on the depth of focus of the objective lens. It is preferable that the first image set includes images of the first sample captured around the focal position. It is also preferable that the first image set includes images of the first sample acquired at the focal position and images of the first sample acquired at positions other than the focal position. If the first sample is a cell, it is preferable that one element of the cell is in focus. For example, if the first sample is an adherent cell in planar culture, it is preferable that any one of the image in which a cell membrane on the adhesive side is in focus, an image in which an intracellular organelle is in focus, and a cell membrane on the non-adherent side is in focus.

The first image group may include a second image set having a plurality of images of the first sample captured at different positions along a second optical axis at a location of the second optical axis different from the location of the first optical axis (S34). The images in the second image set were obtained by capturing a portion of the first sample which is different from the portion appeared in the images in the first image set. The second optical axis is for capturing images of a second imaging location that is different from a first imaging location captured at the first optical axis. The images included in the first image set are different from each other at least in positions along the x- and y-directions when one absolute coordinates in the x- and y-dimensions is determined in the space where the sample is located. For example, with the origin (x0, y0) of the coordinates (x,y) being set at the center of a dish, if the first image set includes images captured at the first position (x1, y1, z1) and images acquired at the second position (x1, y1, z2) that shares the same coordinates as the first position in the x- and y-dimensions but has a different coordinate along the optical axis, the second image set includes images acquired at a third position (x2, y2, any z) that is different from the first image set.

The first image group may further comprise a third image set having a plurality of images of a second sample that is different from the first sample at different positions along a third optical axis (S34). Here, the second sample is different from the first sample as an object, but if the first sample is a cell, it is preferable that the second sample is also a cell. The first sample and the second sample need not be identical in terms of cell type or the species from which the cells are derived. For example, as the source image group, images of iPS cells and Hep cells may be included. Alternatively, for example, as the source image group, images of rat cells and images of mouse cells may be included.

As mentioned above, it is preferable that the same imaging method (e.g., modality) is used for all of the image sets included in the first image group, but a different model of image acquisition device may be used. The accuracy of image transformation is increased through training using a wide variety of image groups as the source images.

The image transformation device acquires from the image acquisition device a second image group having a plurality of phase contrast images of the first sample. The images included in the first image group and those included in the second image group may be pairs of images of the first sample captured either at the same field of view or at different fields of view.

As a method of controlling source image acquisition, as shown in FIG. 3, the number of images included in the first, second, and third image sets may be determined in advance, and an operation flow may be as follows: first images in the first image set are acquired (S31, S32); it is determined whether the acquisition of a predetermined number of images has been completed (S33); if the second or third image set does not have enough images, the remaining images are acquired (S34).

<«Acquisition of Target Images»>

A phase contrast image is acquired as the target image. The phase contrast image is obtained by capturing a third sample by phase contrast observation. The target image and the source image may have an unpaired relationship. Here, the term “unpaired relationship” refers to a situation where a coordinates (x,y) of at least one of the source images is not the same as the coordinates of any target images. Here, the third sample is different as an object from the first sample that is the object to be observed in the source image, but if the first sample is, for example, a cell, it is preferable that the third sample is also a cell. The first and third samples need not be identical in terms of cell type or the biological species from which the cells are derived.

The number of the target images may be at least one, but it is preferable that multiple target images are present. A single image may be divided into smaller images as the target images. The phase contrast images used for training as the target images are those obtained by focusing on the focal position of the biological sample and using phase contrast observation.

«Hyper Parameter Setting»

Next, hyper parameters are set (S43). Examples of the hyper parameters include learning rate and the number of updates of learning. The learning rate may be 0.01, 0.1, or 0.001. The number of updates may be 100, 500, or 1000. The number of updates may vary according to the number of images for training. For example, the higher the number of training images, the fewer the number of updates may be.

«Training»

The source and target images are used as images for training, and training is performed using the hyper parameters that have been set (S44).

In the techniques of the present disclosure, an image transformation network is used; the first image set is used as the source; the second image set is used as the target, mapping of the source to the target is learned; and a learned model is generated. Any image transformation network may be used, and examples include “convolutional neural networks (CNN),” “Generative Adversarial Networks (GAN),” “Conditional GAN (CGAN),” “Deep Conventional GAN (DCGAN),” “Pix2Pix,” and “CycleGAN.” The CycleGAN is preferable since the images in the first and second image groups used in training may be those captured from different fields of view.

A training model is updated until the number of updates reaches a predetermined number (S45). When the number of updates is reached, a learned model is generated (S46).

It is also possible to discontinue updating the training model in the middle of the process. In this case, it is desirable to record a predetermined reference value for each update, plot it against the number of updates based on the recorded reference value, and terminate the update when it is determined to be local minimum or local maximum. An example of a predetermined reference value is a loss function in a training model.

<Modified Version of Image Acquisition>

In the same manner as in the first image group, the image processing system may acquire the first image data (hereinafter referred to as the original image data), which is the original of the biological sample for image transformation, captured by the imaging unit at different positions along the optical axis of the observation unit. This first image data may be acquired from the first image group, or new images of the biological sample may be captured to acquire multiple image data (S71). The position data for each of the first image data is also acquired at this time.

When acquiring the original image, the image processing unit 109 may perform wide-area scanning to thereby judge an approximate location of the focal plane as a pre-processing step, and after the wide-area scanning, perform detailed scanning of the area including the judged focal plane to acquire the original image.

Specifically, first, images are acquired at different positions along the optical axis for a wide range in the direction of the optical axis by wide-area scanning. Then, based on the acquired multiple images, an approximate location of the focal plane is judged and a first area that is narrower in the direction of the optical axis than the wide-area scanning and includes candidate positions for the focal position is determined. For example, approximate locations of bimodal maximum peaks described below are detected during wide-area scanning, and the area between the maximum peaks is determined as the first area. Next, detailed scanning is performed for the first area, and images of multiple different positions along the optical axis are acquired.

The images may be acquired at any interval, but the interval is chosen within an appropriate range depending on the depth of focus of the objective lens. When acquiring multiple images, it is preferable that the images are acquired at equal intervals in the direction of the optical axis. In wide-area scanning, images are acquired at large intervals, and in detailed scanning, images are acquired at smaller intervals than in wide-area scanning.

The resolution of this image may be set by a user depending on a target component and the accuracy of the analysis; if it is desired to see the entire cell, the contour of the cell may be in focus. For example, when the target component is an entire single cell with a diameter of 5 μm to several tens of micrometers, it is preferable that the resolution of the acquired image is from 0.5 μm/pixel or larger to less than 5 μm/pixel so that no single cell fits into a single pixel. When the target component is an intracellular organelle such as a nucleolus whose size is 1 to 3 μm, it is preferable that the resolution of the acquired image is less than 1 μm/pixel.

If multiple images were acquired as the original images for transformation, an image captured at the focal position may be selected from the multiple images as the first image, and the selected image captured at the focal position may be transformed as the artificial phase contrast image. The following is an example of the method of identifying the image of the focal position in a focal position identification unit 115.

For the acquired original image, a processing of generating an image having less image information than the original image is performed (S72), and a second image for calculating a contrast value is generated. Specifically, the second image for calculating the contrast value is obtained through a processing of generating an image in which image information of a component smaller than the target component of the object to be observed for the original image has been reduced. The processing of reducing image information includes smoothing in a luminance or spatial direction. An example of smoothing in the luminance direction is to correct the luminance value of an area to be processed and make it constant, such as bilateral filter processing.

An example of smoothing in the spatial direction is a down-sampling of an image with respect to the spatial direction. Down-sampling is for transforming an image to an image with a lower resolution. An effect of down-sampling is to emphasize the contour of the target component relative to the remainders by removing or blurring the contour(s) of each object that is smaller than the target component and is not required to be observed in the object to be observed. Thus, it is preferable that the amount of down-sampling is such that the object(s) that is/are not required to be observed is/are included in a single pixel in the resolution of the image obtained after down-sampling. Therefore, it is preferable that the resolution of the image after down-sampling is set to 5-15 μm/pixel when the target component is, for example, an entire cell, 3-10 μm/pixel when the target component is the cell nucleus, and 0.5-5 μm/pixel when the target component is a cell organelle such as a mitochondrion or nucleolus. By setting the resolution of the image after down-sampling in this way, an image in which the target component is in focus can be obtained.

Any method of down-sampling can be used, but images are down-sampled using, for example, an average value of multiple pixels. As the average value of multiple pixels, an average value of surrounding pixels whose size depends on the size of the image after down-sampling is used. For example, if the image is reduced to the size of 1/n, an average value of the surrounding n by n pixels is used. For example, the original image may be transformed into a new image by dividing up the original image into blocks each made of multiple pixels on each side, calculating an average luminance for each block, and assigning that average luminance to each pixel in the entire block. Alternatively, a bilinear method may be used, and an image may be transformed into a new image by removing every other pixel in the x-direction. The average luminance of the block may be calculated with the remaining pixels by removing one or more pixels at specific locations in the block, and then assigning that average luminance to each pixel in the entire block.

As a down-sampling processing, it is possible to obtain, by binning, a bright-field image with a desired number of pixels which is fewer than the number of pixels of the bright-field image at the time of observation. The image acquisition device 101 may have an imaging unit 107 with a binning function.

As another smoothing processing, a smoothing filter may be used. A filter such as an averaging filter or a Gaussian filter may be used as the smoothing filter to smooth images in the X- and Y-directions by a convolution operation.

Next, a contrast value of each of the smoothed multiple bright-field images is calculated in a calculation unit 113 (S73). Any method of calculating contrast values can be used, and a method such as a sigma-delta method or a sigma delta square method may be used.

After the contrast values calculated from the multiple images of a phase object are serialized as a function of positions along the optical axis (S74), the contrast values are smoothed (S75) and the local maximum is identified (S76). The position corresponding to the local minimum contrast value is identified between the positions where e contrast values or transformation values are two local maximum values (S77 to S79). The position corresponding to the local minimum can be suitably used as a focal position when observing the phase object. In the technique of the present disclosure, image transformation can be performed using an image acquired at this position corresponding to the smallest value as the original image.

<Modified Version of Image Generation>

Multiple original images may be transformed into average resulting multiple artificial phase contrast images. A specific method therefor is described below.

First images, which are the originals captured by the imaging unit, are acquired at different positions along the optical axis of the observation unit (S81). Among the images obtained at different positions along the optical axis of the observation unit, multiple images to be transformed are selected and supplied to a learned model (S82). For the multiple images to be supplied, it is recommended to select a predetermined number of images that are close to the focused image with the in-focus target component to be observed. Moreover, it is preferable to select images captured at close positions in the direction of the optical axis, and it is especially preferable to select images captured at adjacent positions in the direction of the optical axis.

The supplied first images are transformed and a plurality of second images are obtained (S83). The second images thus obtained are averaged (S84). Any method of averaging can be used. For example, an average luminance can be calculated for each corresponding pixel, and the luminance of that pixel can be used. Finally, the averaged second images are output (S85), and the images are caused to be displayed on the display unit (S86).

By averaging multiple images in this manner, it becomes possible to mitigate the effects of undesirable results, if any, such as abnormal values produced by the style change.

<Programs and Storage Media>

Programs that cause a computer to execute the image processing methods described above and non-transitory computer-readable storage media storing such programs are also embodiments of the technique of the present disclosure.

### Examples

This example shows that images after transformation are still in focus even after supplying, to a learned model, a bright-field image at a focal position on an optical axis and a bright-field image at a position certain distance away from it, and transforming them into artificial phase contrast images.

(1) Original Images

Mixed neurons (Elixirgen Scientific, Inc.) were seeded in 12-well plates and observed using an objective lens with a magnification of 10×. Images were captured at positions Z17 to Z20, including a focal position Z19, which are apart from each other by 5 μm in the direction of the optical axis, and the captured images were used as the original images. For the focal position Z19, a position where the contours of the cells appeared sharp and the contrast of the cells was low was determined as the focal position.

(2) Generation of a Learned Model

CycleGAN was trained using 657 bright-field images and 125 phase contrast images as training images, with a learning rate of 0.0002, the number of updates of 2000, and the batch size of 1. Default parameters were used except for the training data.

(3) Image Transformation

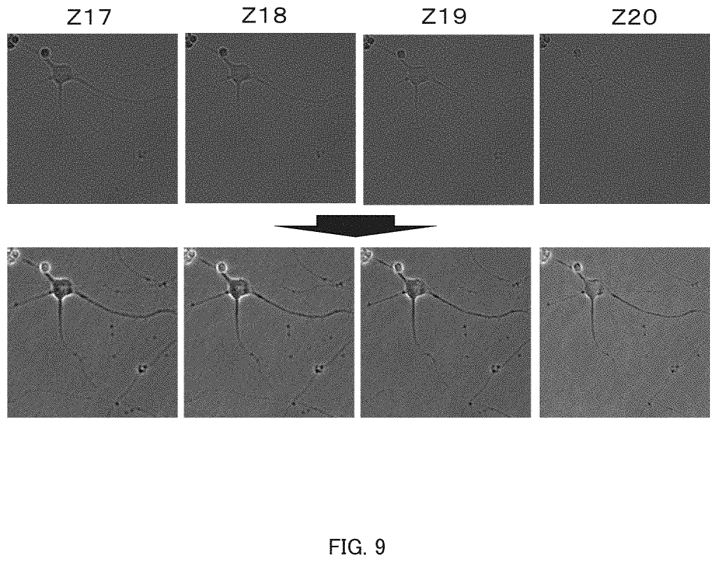

The images at Z17 to Z20 were supplied to the learned model and transformed into artificial phase contrast images. The transformed images are shown in FIG. 9.

From the image in FIG. 9, even an image which is out of focus and blurred as in Z17 and an image having a lower contrast as in Z20 were transformed into images with the same image quality as Z19 which is a focused image.

1. A method for generating a learned model that performs an image transformation, the method comprising:
a step of learning mapping of a source to a target using a first image group as the source and at least one phase contrast image as the target, the first image group comprising a first image set having microscopic images of a biological sample captured at different positions along a first optical axis, the microscopic images being other than phase contrast images.

2. The method according to claim 1, wherein the first image set comprising a microscopic image of the biological sample captured at a focal position and a microscopic image of the first biological sample captured at a position away from the focal position at a certain distance along the first optical axis.

3. The method according to claim 1, wherein the biological sample comprises a cell.

4. The method according to claim 1, wherein the image transformation is performed using a CycleGAN.

5. The method according to claim 1, wherein the first image group comprises a second image set having microscopic images of the biological sample captured at different positions along a second optical axis that is different from the first optical axis.

6. The method according to claim 1, wherein a bright-field image is included in the images in the first image set.

7. An image processing method comprising the steps of:
acquiring a first image of a biological sample for image transformation, the first image being other than a phase contrast image;
supplying the first image to a learned model and performing image transformation to generate a second image, the learned model having been generated using, as data for training, source image data and target image data, the source image data having microscopic images of the first biological sample for training captured at positions different from the first image along an optical axis by the same imaging method as the method used for capturing the first image, the target image data having phase contrast images of a second biological sample for training; and
outputting the second image.

8. The image processing method according to claim 7, wherein the first image was captured at a position other than a focal position of the biological sample f or image transformation.

9. An image processing method comprising the steps of:
acquiring an image set having microscopic images of a biological sample for image transformation captured at different positions along an optical axis of an objective lens, the microscopic images being other than phase contrast images; and
supplying one or more first images selected from the image set to a learned model and performing image transformation to generate one or more second images, the number of the first image(s) being equal to the number of the second image(s), the learned model having been generated using, as data for training, source image data and target image data, the source image data having microscopic images of a first biological sample for training captured by the same imaging method as the method used for capturing the image set, the microscopic images of the source image data being other than phase contrast images, the target image data having phase contrast images of a second biological sample for training.

10. The image processing method according to claim 9, wherein the selected one first image is an image at a focal position.

11. The image processing method according to claim 9, wherein the first image(s) is/are selected from the image set by a method comprising the steps of:
calculating contrast values of the respective microscopic images in the image set;
serializing the contrast values as a function of positions in a direction of the optical axis, and identifying a position corresponding to a local minimum contrast values between the positions where the contrast values are two local maximum values; and
selecting an image at the position corresponding to the local minimum contrast values.

12. The image processing method according to claim 9, wherein first images selected from the image set are supplied to the learned model and subjected to image transformation, thereby second images are generated, the number of the first images being equal to the number of the second images;
the image processing method further comprising the step of averaging the second images.

13. The image processing method according to claim 9, further comprising the step of outputting the second images generated;
the step of outputting the second images comprising:
a sub-step of detecting a position where the biological sample is present in each of the second images; and
a sub-step in which the second images are output along with the position where the biological sample detected is present.

14. An image transformation device comprising the learned model generated using the method according to claim 1.

15. A program that causes a computer to execute the image processing method according to claim 7.
